(19) United States
(12) Patent Application Publication
(10) Pub. No.: US 2006/0050733 A1
(43) Pub. Date: Mar. 9, 2006

(54) Virtual channel arbitration in switched fabric networks

(76) Inventors: Christopher L. Chappell, Chandler, AZ (US); James Mitchell, Chandler, AZ (US)

Correspondence Address: FISH & RICHARDSON, PC, P.O. BOX 1022, MINNEAPOLIS, MN, 55440-1022, US

(21) Appl. No.: 10/934,642

(22) Filed: Sep. 3, 2004

(51) Int. Cl. H04J 3/22

(52) U.S. Cl. 370/468

(57) ABSTRACT

Method and apparatus, including computer program products, implementing techniques for receiving packets including node configuration packets over a plurality of virtual channels of a switch fabric, each node configuration packet including a request for access to a memory space of an Advanced Switching (AS) device, and arbitrating access of the received node configuration packets to the memory space between the plurality of virtual channels.

### BACKGROUND

This invention relates to virtual channel arbitration in switched fabric networks.

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Special Interest Group (PCI-SIG) manages PCI specifications as open industry standards, and provides the specifications to its members Advanced Switching (AS) is a technology which is based on the PCI Express architecture, and which enables standardization of various backplane architectures. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The Advanced Switching Interconnect Special Interest Group (ASI-SIG) is a collaborative trade organization chartered with providing a switching fabric interconnect standard, specifications of which it provides to its members.

### BRIEF DESCRIPTION OF THE DRAWINGS

FIG. 1 is a block diagram of a switched fabric network.

FIG. 2 is a diagram of protocol stacks.

FIG. 3 is a diagram of an AS transaction layer packet (TLP) format.

FIG. 4 is a diagram of an AS route header format.

FIG. 5 is a diagram of a first implementation of an AS device.

FIG. 6 is a diagram of a second implementation of an AS device.

FIG. 7 is a diagram of a third implementation of an AS device.

### DETAILED DESCRIPTION

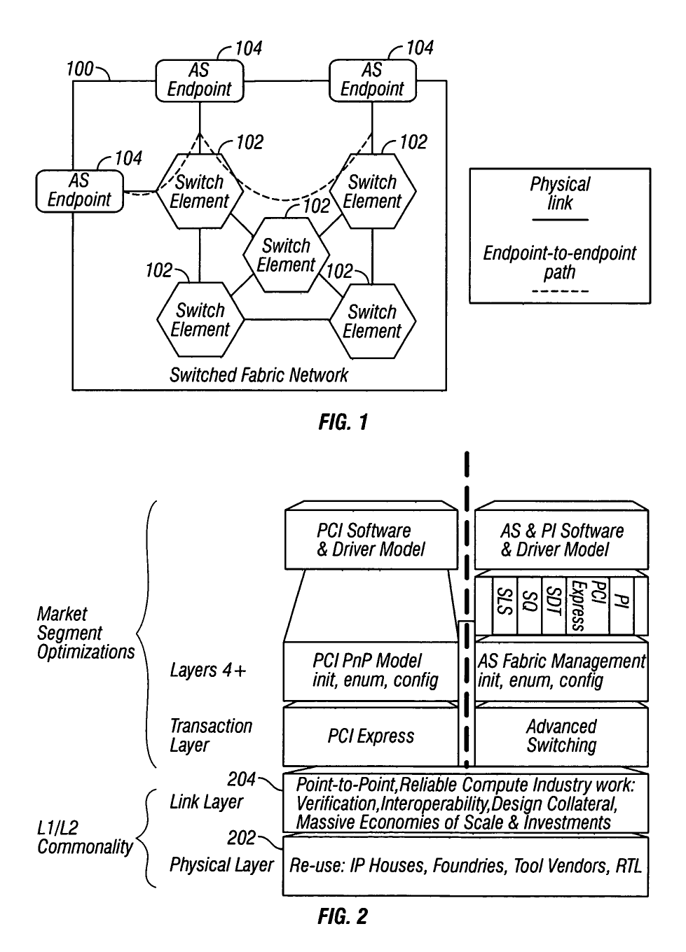

FIG. 1 shows a switched fabric network 100. The network 100 may include switch elements 102 and end points 104, e.g., CPU chipsets, network processors, digital signal processors, media access and host adaptors. The switch elements 102 constitute internal nodes of the network 100 and provide interconnects with other switch elements 102 and end points 104. The end points 104 reside on the edge of the switch fabric and represent data ingress and egress points for the switch fabric. The end points 104 may encapsulate and/or translate packets entering and exiting the switch fabric and may be viewed as “bridges” between the switch fabric and other interfaces (not shown).

Each switch element 102 and end point 104 has an Advanced Switching (AS) interface that is part of the AS architecture defined by the “Advance Switching Core Architecture Specification” (available from the Advanced Switching Interconnect-SIG at www.asi-sig.com). The AS architecture utilizes a packet-based transaction layer protocol that operates over the PCI Express physical and data link layers 202, 204, as shown in FIG. 2.

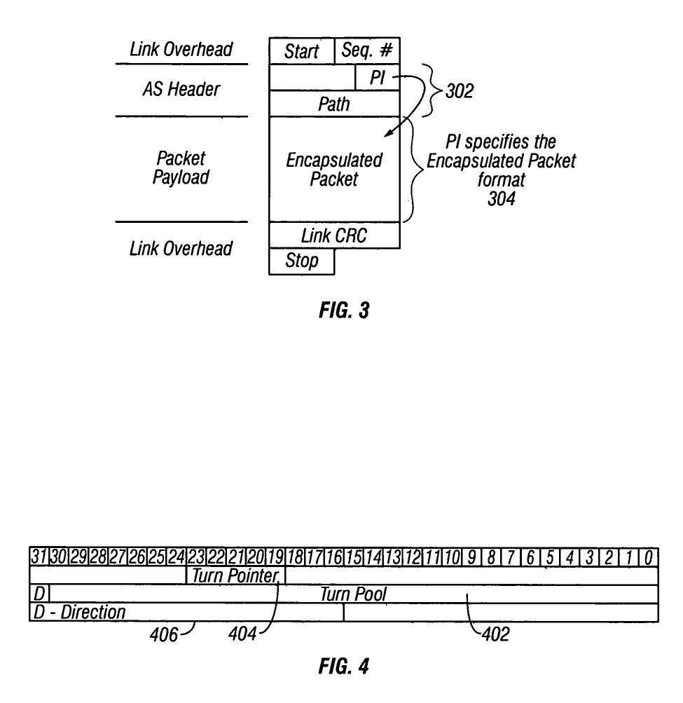

AS uses a path-defined routing methodology in which the source of a packet provides all information required by a switch (or switches) to route the packet to the desired destination. FIG. 3 shows an AS transaction layer packet (TLP) format 300. The packet includes a route header 302 and an encapsulated packet payload 304. The AS route header 302 contains the information that is necessary to route the packet through an AS fabric (i.e., “the path”), and a field that specifies the Protocol Interface (PI) of the encapsulated packet. AS switches route packets using the information contained in the route header 302 without necessarily requiring interpretation of the contents of the encapsulated packet 304.

A path may be defined by the turn pool 402, turn pointer 404, and direction flag 406 in the route header 302, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field in the AS route header 302 determines the format of the encapsulated packet 304. The PI field is inserted by the end point 104 that originates the AS packet and is used by the end point that terminates the packet to correctly interpret the packet contents. The separation of routing information from the remainder of the packet enables as AS fabric to tunnel packets of any protocol.

PIs represent fabric management and application-level interfaces to the switched fabric network 100. Table 1 provides a list of PIs currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-223 | ASI-SIG defined PEIs |
| 224-254 | Vendor-defined PEIs |
| 255 | Invalid |

PIs 0-7 are used for various fabric management tasks, and PIs 8-254 are application-level interfaces. As shown in Table 1, PI-8 is used to tunnel or encapsulate a native PCI Express packet. Other PIs may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the establishment of direct endpoint-to-endpoint logical paths through the switch fabric known as Virtual Channels (VCs), This enables a single switched fabric network to service multiple, independent logical interconnects simultaneously, each VC interconnecting AS end points for control, management and data. Each VC provides its own queue so that blocking in one VC does not cause blocking in another. Each VC may have independent packet ordering requirements, and therefore each VC can be scheduled without dependencies on the other VCs.

The AS architecture defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS architecture provides a number of congestion management techniques, one of which is a credit-based flow control technique that ensures that packets are not lost due to congestion. Link partners (e.g., an end point 104 and a switch element 102) in the network exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes (e.g., forwards to an end point 104) the received packet, space is made available on the corresponding VC and flow control credits are returned to the transmission end of the link. The transmission end of the link then adds the flow control credits to its credit account.

The AS architecture supports the implementation of an AS Configuration Space in each AS device (e.g., AS end point 104) in the network. The AS Configuration Space is a storage area that includes fields to specify device characteristics as well as fields used to control the AS device. The AS Configuration Space includes up to 16 apertures where configuration information can be stored. Each aperture includes up to 4 Gbytes of storage and is 32-bit addressable. The configuration information is presented in the form of capability structures and other storage structures, such as tables and a set of registers. Table 2 provides a set of capability structures (“AS Native Capability Structures”) that are defined by the AS Specification and stored in aperture 0 of the AS Configuration Space.

TABLE 2
AS Native Capability Structures

| | End | Switch |
|---|---|---|
| AS Native Capability Structure | points | Elements |
| Baseline Device | R | R |
| Spanning Tree | R | R |
| Spanning Tree Election | O | N/A |
| Switch Spanning Tree | N/A | R |
| Device PI | O | O |
| Scratchpad | R | R |
| Doorbell | O | O |
| Multicast Routing Table | N/A | O |
| Semaphore | R | R |
| AS Event | R | R |
| AS Event Spooling | O | N/A |
| AS Common Resource | O | N/A |
| Power Management | O | N/A |
| Virtual Channels | R w/OE | R w/OE |
| Configuration Space Permission | R | R |
| End point Injection Rate Limit | O | N/A |
| Status Based Flow Control | O | O |
| Minimum Bandwidth Scheduler | N/A | O |
| Drop Packet | O | O |
| Statistics Counters | O | O |
| SAR | O | N/A |
| Integrated Devices | O | N/A |

Legend:
O = Optional normative
R = Required
R w/OE = Required with optional normative elements
N/A = Not applicable

The information stored in the AS Native Capability Structures can be accessed through node configuration packets, e.g., PI-4 packets, which are used for device management.

In one implementation of a switched fabric network, the AS devices on the network are restricted to read-only access of another AS device's AS Native Capability Structures, with the exception of one or more AS end points that have been elected as fabric managers.

A fabric manager election process may be initiated by a variety of either hardware or software mechanisms to elect one or more fabric managers for the switched fabric network. A fabric manager is an AS end point that “owns” all of the AS devices, including itself, in the network. If multiple fabric managers, e.g., a primary fabric manager and a secondary fabric manager, are elected, then each fabric manager may own a subset of the AS devices in the network. Alternatively, the secondary fabric manager may declare ownership of the AS devices in the network upon a failure of the primary fabric manager, e.g., resulting from a fabric redundancy and fail-over mechanism.

Once a fabric manager declares ownership, it has privileged access to its AS devices' AS Native Capability Structures. In other words, the fabric manager has read and write access to the AS Native Capability Structures of all of the AS devices in the network.

As previously discussed, the AS Native Capability Structures of an AS device are accessible through PI-4 packets. Accordingly, each AS device in the switched fabric network can be implemented to include an AS PI-4 unit for processing PI-4 packets received through the network from a fabric manager or another AS device. In the examples to follow, the term “local AS device” refers to an AS device that has received a PI-4 packet and is processing the PI-4 packet, and the term “remote AS device” refers to an AS device, e.g., a fabric manager or another AS device, on the network that is attempting to access the local AS device's AS Native Capability Structures.

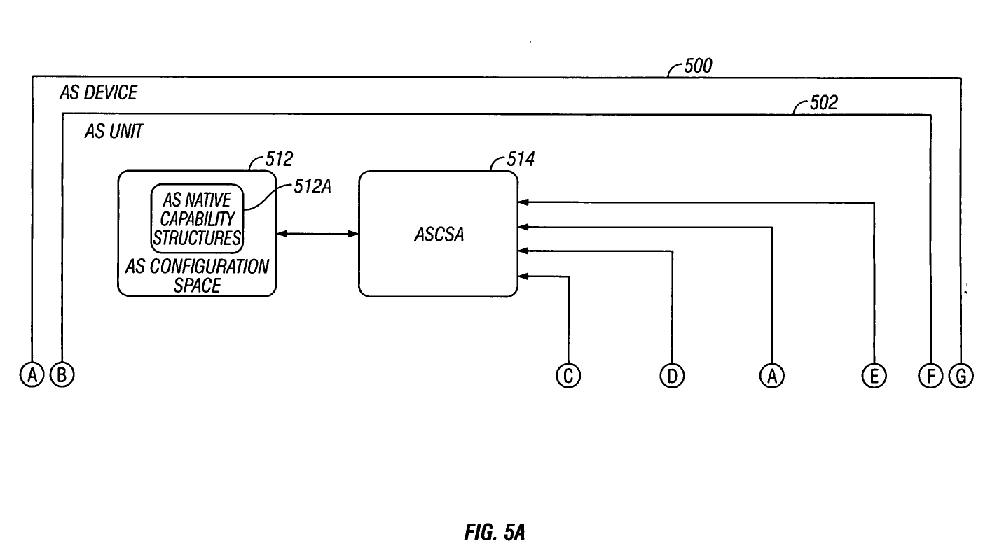

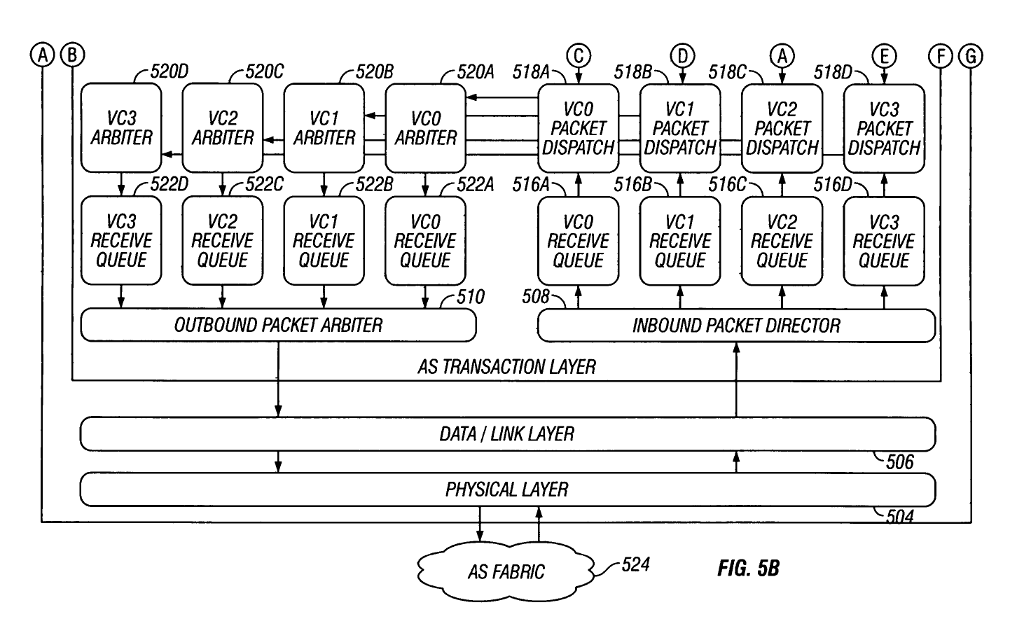

Referring to FIG. 5, the local AS device 500 includes an AS unit 502 that implements the AS transaction layer operating over the physical layer 504 and data/link layer 506. In one example, the AS unit 502 includes an inbound packet director 508, an outbound packet arbiter 510, multiple VC units, an AS Configuration Space 512, and an AS Configuration Space Access (“ASCSA”) unit 514. The AS Configuration Space 512 includes one or more AS Native Capability Structures 512a. In one implementation, each VC unit includes a VC receive queue 516a-516d, a VC packet dispatch unit 518a-518d, a VC arbiter 520a-520d and a VC transmit queue 522a-522d. Each VC supported by the local AS device 500 is associated with a VC receive queue 516a-516d and a VC transmit queue 522a-522d.

Packets received at the local AS device 500 over a switch fabric 524 are passed from the physical layer 504 and data/link layer 506 to the inbound packet director 508. The inbound packet director writes each incoming packet to a VC receive queue 516a-516d of a VC unit based on a TC-to-VC mapping that is stored at (or is otherwise accessible by) the inbound packet director 508. In the example of FIG. 5, an incoming packet may be written to one of 4 VC receive queues: VC0 receive queue 516a, VC1 receive queue 516b, VC2 receive queue 516c, and VC3 receive queue 516d.

Each VC receive queue 516a-516d can be implemented as a first-in-first-out (FIFO) structure that passes packets to its corresponding VC packet dispatch unit 518a-518d in the order it receives them. For example, packets on the VC2 receive queue 516c are passed to its corresponding VC2 packet dispatch unit 518c. Upon receipt of a packet, the VC packet dispatch unit 518a-518d determines the format of the packet by inspecting the PI field of the AS route header. For PI-4 packets, the VC packet dispatch 518a-518d performs one or more PI-4 packet validation operations. In one example, the VC packet dispatch unit 518a-518d performs a payload check to determine whether the actual payload size of the packet is equal to the payload size indicated in the packet header. In another example, the VC packet dispatch unit 518a-518d performs a configuration space permissions check to determine whether the AS device from which the PI-4 packet originated has the appropriate permission, e.g., a write permission, to access the target AS device's AS Native Capability Structures 512a.

If the PI-4 packet is invalid, the VC packet dispatch unit 518a-518d discards the PI-4 packet, generates an error signal, and sends the error signal to a processor (not shown) external to the VC packet dispatch unit 518a-518d. In one implementation, the external processor generates a PI-5 (event notification) packet in response to the error signal.

If the PI-4 packet is valid, the VC packet dispatch unit 518a-518d identifies the packet type using the field values associated with an Operation Type field in the AS route header. Table 3 shows how a packet is identified using the Operation Type field.

TABLE 3
PI-4 packet types

| PI-4 Packet Type | Operation Type |
|---|---|
| Write | 000 |
| Read Request | 100 |
| Read Completion with Data | 101 |
| Read Completion with Error | 111 |

For each valid PI-4 packet, the VC packet dispatch unit 518a-518d sends an access request (e.g., a read request or a write request) to the ASCSA unit 514 for processing. The access request includes an aperture number and address (corresponding to the PI-4 packet header) of a location in the AS Configuration Space 512.

In one implementation, the ASCSA unit 514 arbitrates access to the AS Configuration Space 512 between the multiple access requests sent by the VC packet dispatch units 518a-518d in a round-robin fashion. The ASCSA unit 514 optionally between access requests including those originated at a processor (not shown) local to the AS device 500 and received over communications paths other than a virtual channel of the switch fabric 524. If an access request is a write request, the ASCSA unit 514 writes data to a location in an AS Native Capability Structure 512a specified by the aperture number and address specified by the access request.

If an access request is a read request, the ASCSA unit 514 retrieves data from a location in the AS Native Capability Structure 512a specified by an aperture number and address specified by the access request. If a failure occurs before or while the data is being retrieved from the AS Native Capability Structure 512a, the ASCSA unit generates an error signal and sends the error signal to the VC packet dispatch unit 518a-518d that originated the access request (“originating VC packet dispatch unit”). In response to the error signal, the originating VC packet dispatch unit 518a-518d generates an AS payload having a PI-4 Read Completion with Error packet header. Within the PI-4 Read Completion with Error packet header, the VC packet dispatch unit 518a-518d provides a value in a Status Code field that indicates the type of failure that occurred during the data retrieval process. Any partial data that may have been retrieved is typically discarded rather than included in the payload of the generated packet for transmission to the remote AS device.

If the data retrieval is successful, the originating VC packet dispatch unit 518a-518d generates an AS payload by appending the retrieved data to a PI-4 Read Completion with Data packet header. Within the PI-4 Read Completion with Data packet header, the originating VC packet dispatch unit 518a-518d provides a value in the Payload Size field that indicates the size of the retrieved data.

In both cases, the VC packet dispatch unit 518a-518d generates a PI-4 packet by attaching an AS route header to the AS payload. The VC packet dispatch unit 518a-518d sends the generated PI-4 packet to its corresponding VC arbiter 520a-520d. For example a PI-4 packet generated by the VC2 packet dispatch unit 518c is sent to the VC2 arbiter 520c, which passes the PI-4 packet to the VC2 transmit queue 522c.

In one implementation, the outbound packet arbiter 510 retrieves the PI-4 packets from the VC transmit queues 522a-522d in round-robin fashion and transfers the PI-4 packets to a remote AS device (not shown) through the switch fabric 524.

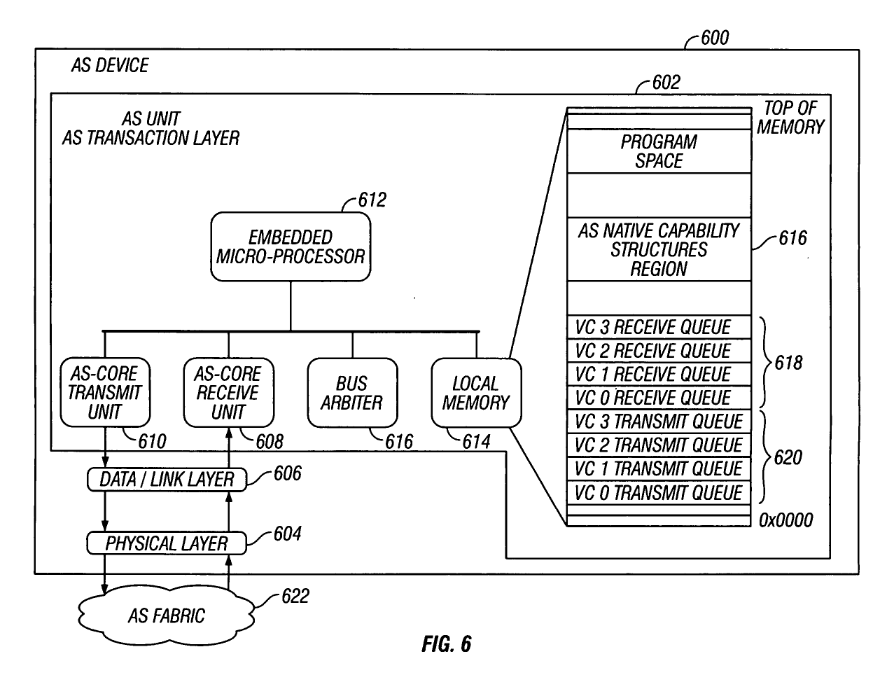

Referring to FIG. 6, the local AS device 600 includes an AS unit 602 that implements the AS transaction layer operating over the physical layer 604 and data/link layer 606. In one example, the AS unit 602 includes an AS-Core receive unit 608, an AS-Core transmit unit 610, and an embedded micro-processor 612 connected to a local memory 614 by a bus. The local memory 614 includes an AS Native Capability Structures region 616, multiple VC receive queues 618, and multiple VC transmit queues 620. Each VC supported by the local AS device 600 is associated with a VC receive queue and a VC transmit queue.

When access to the local memory 614 is requested by the AS-Core receive unit 608, the AS-Core transmit unit 610, and the embedded micro-processor 612, a bus arbiter 616 authorizes the access using an arbitration scheme. Arbitration schemes typically try to balance two factors in choosing which device (i.e., the AS-Core receive unit 608, the AS-Core transmit unit 610, and the embedded micro-processor 612) to grant access to the bus. First, each device has a bus priority, and the highest-priority devices are serviced first. Second, to assure that no device, even with low priority, is completely locked out, the bus arbiter 616 uses a round-robin fairness protocol that does not grant a device which has just completed a bus operation access to the bus for a second operation until all the requesting devices have first been granted access to the bus.

Packets received at the local AS device 600 are passed from the physical layer 604 and data/link layer 606 to the AS-Core receive unit 608. For each incoming packet, the AS-Core receive unit 608 allocates a packet descriptor from a packet descriptor pool stored in the local memory 614 to the packet, stores the packet in a buffer location corresponding to the allocated packet descriptor, and pushes the packet descriptor onto a VC receive queue 618. In one implementation, the packet descriptor is pushed onto a VC receive queues 618 based on a TC-to-VC mapping that is stored at (or is otherwise accessible by) the AS-Core receive unit 608. In the example of FIG. 6, a descriptor may be pushed onto one of 4 VC receive queues 618: VC0 receive queue, VC1 receive queue, VC2 receive queue, and VC3 receive queue.

The embedded micro-processor 612 may be notified of an incoming packet by an interrupt that is generated when a descriptor is pushed onto a VC receive queue 618 or by periodically polling the VC receive queues 618. In one implementation, the embedded micro-processor 612 services the multiple VC receive queues 618 in a weighted round-robin fashion, and processes the packets within each VC receive queue 618 in the order in which they are received.

To process a packet, the embedded micro-processor 612 pulls a packet descriptor from the head of a VC receive queue 618 and stores VC context information in the local memory 614. The VC context information identifies the VC receive queue 617 from which the packet descriptor was pulled. The embedded micro-processor 612 examines the packet stored in the buffer location corresponding to the packet descriptor to determine the format of the packet, e.g., by inspecting the PI field of the packet's AS route header. For PI-4 packets, the embedded micro-processor 612 performs one or more PI-4 packet validation operations (e.g.., a payload check or a configuration space permissions check).

If the PI-4 packet is invalid, the embedded micro-processor 612 discards the PI-4 packet, generates an error signal, and sends the error signal to a processor (not shown) external to the embedded micro-processor 612. In one implementation, the external processor generates a PI-5 (event notification) packet in response to the error signal.

If the PI-4 packet is valid, the embedded micro-processor 612 identifies the packet type using the field values associated with an Operation Type field in the AS route header. For a valid PI-4 write request packet, the embedded micro-processor 612 extracts data from the PI-4 packet and writes the data to a register location (corresponding to the aperture number and address specified by the PI-4 packet header) in the AS Native Capability Structures region in the local memory 614.

For a valid PI-4 read request packet, the embedded micro-processor 612 reads the data from a register location (corresponding to the aperture number and address specified by the PI-4 packet header) in the AS Native Capability Structures region 616 in the local memory 614. If a failure occurs before or while the data is being retrieved from the AS Native Capability Structures region 616, the embedded micro-processor 612 generates an AS payload having a PI-4 Read Completion with Error packet header. Within the PI-4 Read Completion with Error packet header, the embedded-microprocessor provides a value in a Status Code field that indicates the type of failure that occurred during the data retrieval process. Any partial data that may have been retrieved is typically discarded rather than included in the payload of the generated packet for transmission to the remote AS device.

If the data retrieval is successful, the embedded micro-processor 612 generates an AS payload by appending the retrieved data to a PI-4 Read Completion with Data packet header. Within the PI-4 Read Completion with Data packet header, the embedded micro-processor 612 provides a value in the Payload Size field that indicates the size of the retrieved data.

In both cases, the embedded micro-processor 612 generates a PI-4 packet by attaching an AS route header to the AS payload. For each outgoing PI-4 packet, the embedded micro-processor 612 unit allocates a packet descriptor from a packet descriptor pool stored in the local memory 614 to the packet, stores the outgoing PI-4 packet in a buffer location corresponding to the allocated packet descriptor, and uses the VC context information stored in memory to select a VC transmit queue 620 onto which the packet descriptor is pushed. For example, if a packet descriptor allocated to an incoming packet is pulled from the VC1 receive queue, the packet descriptor allocated to the corresponding outgoing packet is pushed onto the VC1 transmit queue.

The AS-Core transmit unit 610 retrieves the packet descriptors from the VC transmit queues 620 in round-robin fashion, and transfers the PI-4 packets from the corresponding buffer locations in the local memory 614 to a remote AS device through the switch fabric 622.

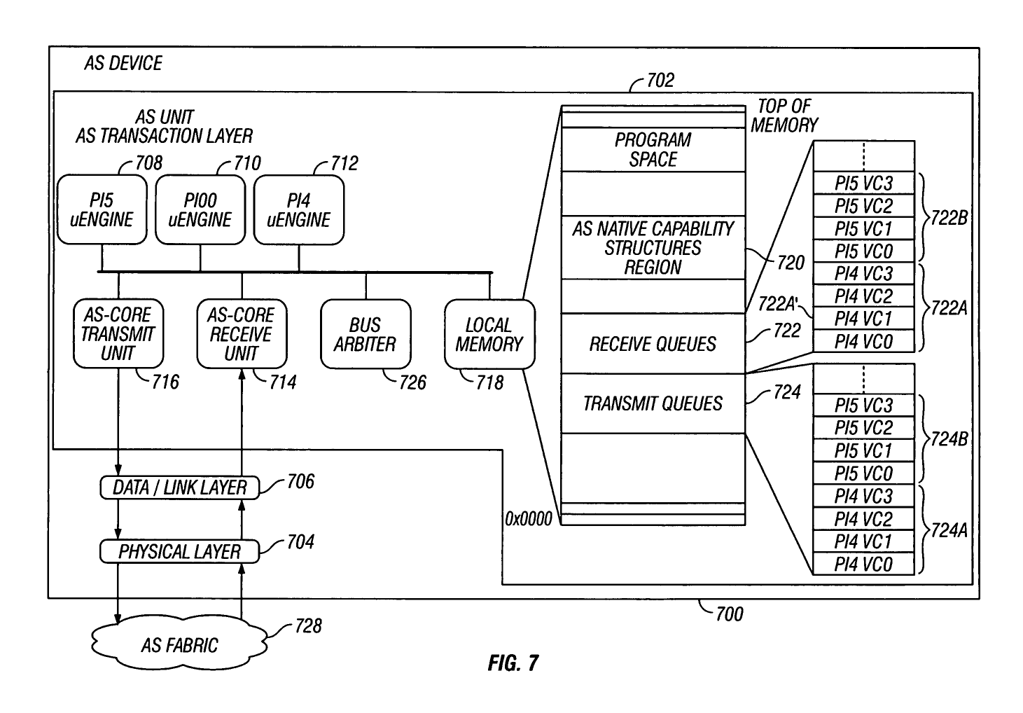

Referring to FIG. 7, the local AS device 700 includes an AS unit 702 that implements the AS transaction layer operating over the physical layer 704 and data/link layer 706. In one example, the AS unit 700 includes multiple micro-engines 708, 710, 712 for processing each of the different types of PI traffic, an AS-Core receive unit 714, and an AS-Core transmit unit 716 connected to a local memory 718 by a bus. The local memory 718 includes an AS Native Capability Structures region 720, multiple VC receive queues 722, and multiple VC transmit queues 724. Each VC receive queue 722 and VC transmit queue 724 is associated with a particular type of PI traffic.

When access to the local memory 718 is requested by the AS-Core receive unit 714, the AS-Core transmit unit 716, and the multiple micro-engines 708, 710, 712, a bus arbiter 726 authorizes the access using one or more arbitration schemes. Unlike the arbitration scheme described above with respect to FIG. 6 which is applied to all types of PI traffic, the bus arbiter 726 in FIG. 7 may implement different arbitration schemes for each of the micro-engines in order to tune system efficiency. For example, the bus arbiter 726 may grant access in a weighted round robin fashion.

Packets received at the local AS device 700 are passed from the physical layer 704 and data/link layer 706 to the AS-Core receive unit 714. For each incoming packet, the AS-Core receive unit 714 determines the format of the packet by inspecting the PI field of the packet's AS route header. The AS-Core receive unit 714 then allocates a packet descriptor from a packet descriptor pool stored in the local memory 718 to the packet, stores the packet in a buffer location corresponding to the allocated packet descriptor, and pushes the packet descriptor onto an appropriate VC receive queue 722. In one implementation, the packet descriptor is pushed onto a VC receive queue 722 based on a TC-to-VC mapping that is stored at (or is otherwise accessible by) the AS-Core receive unit 714. In the example of FIG. 7, the AS-Core receive unit 714 may push a packet descriptor allocated to an incoming PI-4 packet onto one of 4 PI-4 VC receive queues 722a: PI-4 VC0 receive queue, PI-4 VC1 receive queue, PI-4 VC2 receive queue, and PI-4 VC3 receive queue. Similarly, the AS-Core receive unit 714 may push a packet descriptor allocated to an incoming PI-5 packet onto one of 4 PI-5 VC receive queues 722b.

The micro-engines 708, 710, 712 may be notified of an incoming packet by an interrupt that is generated when a descriptor is pushed onto their respective VC receive queues or by periodically polling their respective VC receive queues 722. In one implementation, each of the micro-engines 708, 710, 712 service their respective VC receive queues 722 in a weighted round-robin fashion, and process the packets within each VC receive queue 722 in the order in which they are received.

For example, to process a PI-4 packet at the head of the PI-4 VC1 receive queue 722a′, the PI-4 micro-engine 712 first performs one or more PI-4 packet validation operations (e.g., a payload check or a configuration space permissions check). If the PI-4 packet is invalid, the PI-4 micro-engine 712 generates an error signal, sends the error signal to the PI-5 micro-engine 708, and discards the PI-4 packet.

In one implementation, the PI-5 micro-engine 708 generates a PI-5 (event notification) packet in response to the error signal. The PI-5 micro-engine 708 uses the turn pool, turn pointer, and other information provided in the route header of the PI-4 packet to form an AS route header, which is appended to an AS payload that identifies the event condition (e.g., configuration space permissions protection error). The generated PI-5 packet is written to a buffer location in the local memory 718. The PI-5 micro-engine 708 pushes a packet descriptor (e.g., with a pointer to the buffer which stores the outgoing PI-5 packet) to a PI-5 VC transmit queue 724b.

If the PI-4 packet is valid, the PI-4 micro-engine 712 identifies the packet type using the field values associated with an Operation Type field in the AS route header. For a valid PI-4 write request packet, the PI-4 micro-engine 712 extracts data from the PI-4 packet and writes the data to a register location (corresponding to the aperture number and address specified by the PI-4 packet header) in the AS Native Capability Structures region 720 in the local memory 718.

For a valid PI-4 read request packet, the PI-4 micro-engine 712 reads the data from a register location (corresponding to the aperture number and address specified by the PI-4 packet header) in the AS Native Capability Structures region 720 in the local memory 718. If a failure occurs before or while the data is being retrieved from the AS Native Capability Structures region 720, the PI-4 micro-engine 712 generates an AS payload having a PI-4 Read Completion with Error packet header. Within the PI-4 Read Completion with Error packet header, the PI-4 micro-engine 712 provides a value in a Status Code field that indicates the type of failure that occurred during the data retrieval process. Any partial data that may have been retrieved is typically discarded rather than included in the payload of the generated packet for transmission to the remote AS device.

If the data retrieval is successful, the PI-4 micro-engine 712 generates an AS payload by appending the retrieved data to a PI-4 Read Completion with Data packet header. Within the PI-4 Read Completion with Data packet header, the PI-4 micro-engine 712 provides a value in the Payload Size field that indicates the size of the retrieved data.

In both cases, the PI-4 micro-engine 712 generates a PI-4 packet by attaching an AS route header to the AS payload, and writes the generated PI-4 packet to a buffer location in the local memory 718. The PI-4 micro-engine 712 pushes a packet descriptor (e.g., with a pointer to the buffer which stores the outgoing packet) to a PI-4 VC transmit queue 724a.

The AS-Core transmit unit 716 retrieves the packet descriptors from the multiple VC transmit queues 724 in round-robin fashion, and transfers the packets from the corresponding buffer locations in the local memory 718 to a remote AS device through the switch fabric 726.

The invention and all of the functional operations described in this specification can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method comprising:
receiving packets including node configuration packets over a plurality of virtual channels of a switch fabric, each node configuration packet including a request for access to a memory space of an Advanced Switching (AS) device; and
arbitrating access of the received node configuration packets to the memory space between the plurality of virtual channels.

2. The method of claim 1, further comprising:
for each received packet, determining a format of the received packet, and performing a packet validation operation on the received packet based on the determined format to determine if the received packet is valid.

3. The method of claim 2, further comprising:
if the received packet is determined to be a valid node configuration packet, identifying a memory space access request type of the valid node configuration packet.

4. The method of claim 3, further comprising:
if the identified memory space access request type comprises a write request, processing the valid node configuration packet to write data to a location in the memory space.

5. The method of claim 3, further comprising:
if the identified memory space access request type comprises a read request, processing the valid node configuration packet to retrieve data from a location in the memory space, and generate a data packet including the retrieved data.

6. The method of claim 1, wherein access is arbitrated using a technique comprising one of a round-robin technique, a weighted round-robin technique, and a round robin technique including a fairness protocol.

7. The method of claim 1, wherein the memory space comprises a capabilities structures region, a plurality of virtual channel receive queues, and a plurality of virtual channel transmit queues, wherein each virtual channel receive queue is associated with a virtual channel of the switch fabric, and each virtual channel transmit queue is associated with a virtual channel of the switch fabric.

8. The method of claim 7, further comprising:
for each packet received over a virtual channel, allocating a packet descriptor to the received packet;
storing the received packet in a buffer location corresponding to the allocated packet descriptor; and
pushing the packet descriptor onto a virtual channel receive queue associated with the virtual channel over which the packet is received.

9. The method of claim 8, wherein arbitrating access comprises:
servicing the plurality of virtual channel receive queues using a technique comprising one of a round-robin technique, a weighted round-robin technique, and a round robin technique including a fairness protocol.

10. The method of claim 9, wherein servicing comprises:
pulling a packet descriptor from a head of a virtual channel receive queue; and
processing the packet stored in a buffer location corresponding to the pulled packet descriptor.

11. An article comprising a machine-readable medium including machine-executable instructions, the instructions to cause the machine to:
receive packets including node configuration packets over a plurality of virtual channels of a switch fabric, each node configuration packet including a request for access to a memory space of an Advanced Switching (AS) device; and
arbitrate access of the received node configuration packets to the memory space between the plurality of virtual channels.

12. The article of claim 11, further comprising instructions to cause the machine to:
for each received packet, determine a format of the received packet, and perform a packet validation operation on the received packet based on the determined format to determine if the received packet is valid.

13. The article of claim 12, further comprising instructions to cause the machine to:
identify a memory space access request type of the valid node configuration packet if the received packet is determined to be a valid node configuration packet.

14. The article of claim 12, further comprising instructions to cause the machine to:
process the valid node configuration packet to write data to a location in the memory space if the identified memory space access request type comprises a write request.

15. The article of claim 12, further comprising instructions to cause the machine to:
process the valid node configuration packet to retrieve data from a location in the memory space and generate a data packet including the retrieved data if the identified memory space access request type comprises a read request.

16. The article of claim 11, wherein instructions to arbitrate access comprise instructions to cause the machine to arbitrate access using a technique comprising one of a round-robin technique, a weighted round-robin technique, and a round robin technique including a fairness protocol.

17. The article of claim 11, wherein the memory space comprises a capabilities structures region, a plurality of virtual channel receive queues, and a plurality of virtual channel transmit queues, wherein each virtual channel receive queue is associated with a virtual channel of the switch fabric, and each virtual channel transmit queue is associated with a virtual channel of the switch fabric.

18. The article of claim 17, further comprising instructions to cause the machine to:
for each packet received over a virtual channel, allocate a packet descriptor to the received packet;
store the received packet in a buffer location corresponding to the allocated packet descriptor; and
push the packet descriptor onto a virtual channel receive queue associated with the virtual channel over which the packet is received.

19. The article of claim 18, further comprising instructions to cause the machine to:
service the plurality of virtual channel receive queues using a technique comprising one of a round-robin technique, a weighted round-robin technique, and a round robin technique including a fairness protocol.

20. The article of claim 19, further comprising instructions to cause the machine to:
pull a packet descriptor from a head of a virtual channel receive queue; and
process the packet stored in a buffer location corresponding to the pulled packet descriptor.

21. An apparatus comprising:
a virtual channel unit operative to:
receive packets including node configuration packets over a plurality of virtual channels of a switch fabric, each node configuration packet including a request for access to a memory space of an Advanced Switching (AS) device; and
for each received node configuration packet, perform a packet validation operation to determine if the received node configuration packet is valid, and if so, send the access request included in the valid node configuration packet to a memory space access unit for processing; and
a memory space access unit operative to:
arbitrate access to the memory space between the plurality of access requests included in the valid node configuration packets received over the plurality of virtual channels.

22. The apparatus of claim 21, wherein the memory space access unit is further operative to:
for each access request, identify a memory space access request type, and if the identified access request type comprises a write request, process the valid node configuration packet to write data to a location in the memory space.

23. The apparatus of claim 21, wherein the memory space access unit is further operative to:
for each access request, identify a memory space access request type, and if the identified access request type comprises a read request, process the valid node configuration packet to retrieve data from a location in the memory space, and generate a data packet including the retrieved data.

24. The apparatus of claim 21, wherein the memory space access unit is operative to arbitrate access using a technique comprising one of a round-robin technique, a weighted round-robin technique, and a round robin technique including a fairness protocol.

25. An apparatus comprising:
a receive unit operative to:
receive packets including node configuration packets over a plurality of virtual channels of a switch fabric, each node configuration packet including a request for access to a memory space of an Advanced Switching (AS) device;
allocate a packet descriptor to the received packet;
store the received packet in a buffer location corresponding to the allocated packet descriptor; and
push the packet descriptor onto a virtual channel receive queue associated with the virtual channel over which the packet is received.

26. The apparatus of claim 25, further comprising:
an embedded micro-processor operative to:
service the plurality of virtual channel receive queues using a technique comprising one of a round-robin technique, a weighted round-robin technique, and a round robin technique including a fairness protocol.

27. The apparatus of claim 26, wherein the embedded micro-processor is operative to:
pull a packet descriptor from a head of a virtual channel receive queue; and
process the packet stored in a buffer location corresponding to the pulled packet descriptor.

28. The apparatus of claim 27, wherein the embedded micro-processor is operative to:
identify the packet stored in the buffer location as being a node configuration packet including a write request; and
write data provided in the packet stored in the buffer location to a location in the memory space.

29. The apparatus of claim 27, wherein the embedded micro-processor is operative to:
identify the packet stored in the buffer location as being a node configuration packet including a read request;
retrieve data from a location in the memory space specified in the packet stored in the buffer location; and
generate a data packet including the retrieved data.

30. An apparatus comprising:
a receive unit operative to:
receive packets including node configuration packets over a plurality of virtual channels of a switch fabric, each node configuration packet including a request for access to a memory space of an Advanced Switching (AS) device; and
for each received packet,
examine the received packet to identify a packet format;
allocate a packet descriptor to the received packet based on its identified packet format;
store the received packet in a buffer location corresponding to the allocated packet descriptor; and
push the packet descriptor onto a virtual channel receive queue based on the packet format of the received packet.

31. The apparatus of claim 30, further comprising:
one or more micro-engines, each micro-engine being associated with one or more virtual channel receive queues, each micro-engine being operative to:
service the one or more associated virtual channel receive queues using a technique comprising one of a round-robin technique, a weighted round-robin technique, and a round robin technique including a fairness protocol.

32. The apparatus of claim 31, wherein to service the one or more associated virtual channel receive queues, the micro-engine is operative to:
pull a packet descriptor from a head of an associated virtual channel receive queue; and
process the packet stored in a buffer location corresponding to the pulled packet descriptor.

33. The apparatus of claim 32, wherein to process the packet, the micro-engine is operative to:
identify the packet stored in the buffer location as being a node configuration packet including a write request; and
write data provided in the packet stored in the buffer location to a location in the memory space.

34. The apparatus of claim 32, wherein to process the packet, the micro-engine is operative to:
identify the packet stored in the buffer location as being a node configuration packet including a read request;
retrieve data from a location in the memory space specified in the packet stored in the buffer location; and
generate a data packet including the retrieved data.

35. A system comprising:
a first device that communicates with a second device over an Advanced Switching fabric, the first device capable of:
receiving packets including node configuration packets over a plurality of virtual channels of the Advanced switching fabric, each node configuration packet including a request for access to a memory space of the first device; and
arbitrating access of the received node configuration packets to the memory space between the plurality of virtual channels.

36. The system of claim 35, wherein the first device is further capable of:
for each received packet, determining a format of the received packet, and performing a packet validation operation on the received packet based on the determined format to determine if the received packet is valid.
